(19) United States
(12) Patent Application Publication
(10) Pub. No.: US 2025/0038303 A1
(43) Pub. Date: Jan. 30, 2025

(54) Battery Pack

(71) Applicant: LG Energy Solution, Ltd., Seoul (KR)

(72) Inventors: Dae Gil Kim, Daejeon (KR); Jae Hyun Lee, Daejeon (KR); Ju Hwan Shin, Daejeon (KR); Hyoung Suk Lee, Daejeon (KR)

(73) Assignee: LG Energy Solution, Ltd., Seoul (KR)

(21) Appl. No.: 18/710,801

(22) PCT Filed: Jun. 29, 2023
(86) PCT No.: PCT/KR2023/009174

§ 371 Date: May 16, 2024

(30) Foreign Application Priority Data
Jul. 1, 2022 (KR) 10-2022-0081128

(51) Int. Cl. H01M 10/6568; H01M 10/613; H01M 10/6556; H01M 50/233; H01M 50/271

(52) U.S. Cl. CPC H01M 10/6568; H01M 10/613; H01M 10/6556; H01M 50/233; H01M 50/271

(57) ABSTRACT

The present technology relates to a battery pack. More specifically, the battery pack of the present technology includes a pack case that includes a module area in which the battery modules are mounted, and a base plate defining a hollow shape and having a plurality of space parts formed therein to support a lower part of a battery module and in which coolant is stored; sidewalls coupled to a rim of the base plate; and a separation wall coupled to the base plate to separate the battery modules from each other. The separation wall includes a main separation wall extended and formed across a central part of the pack case. The base plate thus enables coolant to flow in out to the space part and an inlet and an outlet at each end connecting the space parts with each other located between a pair of adjacent space parts, and further includes a flow path part including a plurality of cooling flow paths to connect the space parts each other.

### CROSS-REFERENCE TO RELATED APPLICATIONS

This application is a national phase entry under 35 U.S.C. § 371 of PCT/KR2023/009174 filed Jun. 29, 2023, which claims the benefit of priority from Korean Patent Application No. 10-2022-0081128, filed on Jul. 1, 2022, all the contents of which hereby incorporated herein by reference.

### TECHNICAL FIELD

The present disclosure relates to a battery pack, and more specifically, the battery pack of the present disclosure provides a pack case having a structure of maximizing the cooling efficiency of accommodated battery module using coolant that flows inside.

### BACKGROUND ART

An operating voltage of the unit secondary battery cell is about 2.5V to 4.2V. Therefore, if a higher output voltage is required, a plurality of battery cells may be connected in series to configure a battery pack. In addition, depending on the charge/discharge capacity required for the battery pack, a plurality of battery cells may be connected in parallel to configure a battery pack. Thus, the number of battery cells included in the battery pack may be variously set according to the required output voltage or the charge/discharge capacity.

For example, when a plurality of battery cells is connected in series or in parallel to configure a battery pack, it is common to configure a battery module composed of a plurality of battery cells first.

A conventional battery pack comprises a pack case in which battery modules are accommodated, and a top cover coupled to the pack case to cover the battery modules accommodated in the pack case.

The pack case may be formed with an inner space surrounded by side walls, and a plurality of battery modules are separately accommodated in a section formed by a plurality of separation walls.

Recently, the demand for large-capacity battery packs applied to electric vehicles, etc. has been increasing.

The battery modules included in a large capacity battery pack such as the above may have performance largely determined according to temperature, and the temperature of each of the battery modules may increase during charging and discharging. In other words, the battery pack may include a plurality of battery modules, and the plurality of battery modules may preferably be managed so that the temperature difference among them is minimized.

The electric vehicle may be equipped with a battery cooling device that cools each of the battery modules accommodated in the battery pack to prevent overheating of these battery modules and thereby maintain the performance of the battery modules.

A representative battery cooling device is a water-cooled battery cooling device. The water-cooled cooling device operates on the principle of cooling each battery module by supplying water cooled to a low temperature to the battery pack in which the battery modules are accommodated.

FIG. 1 is a perspective view of a battery pack applied to an electric vehicle with a water-cooled cooling device, and FIG. 2 is a front view of the battery pack of FIG. 1. Since each battery module included in the battery pack, as shown in FIGS. 1 and 2, is accommodated in a nearly enclosed space by the top cover 10 covering the top of the battery pack and the side walls 30 covering the sides the battery pack operates in an environment that is highly vulnerable to heating.

Therefore, in order to cool the battery module, conventional methods have been used to allow coolant to flow to a base plate 20 corresponding to the bottom of the battery pack.

Referring to FIGS. 1 and 2, the base plate 20, which corresponds to the lower part of the battery pack, has a plurality of tube-shaped flow paths 80 installed therein, and the low-temperature coolant injected through the inlet 40 is divided into a plurality of hoses 70 connected to the inlet 40, and then moves to each flow path 80 through the auxiliary inlet 60 connected to the hoses 70.

FIG. 3 is a brief diagram of the path Ct that coolant flows through the flow paths 80 in the battery pack of FIG. 1. Referring to FIG. 3, coolant is introduced into each of the auxiliary inlets 60 and flows in one direction through the channels 80 associated with the auxiliary inlets 60 to cool the battery modules accommodated in the battery pack, and is discharged through the outlet 50.

However, a battery pack having the above structure has the disadvantage of complicated assembly, requiring a process of connecting inlets, outlets, hoses, auxiliary inlets, and flow channels.

In addition, the cross-section of the flow channel is a round shape, and there is a disadvantage that the area in contact with the battery module actually accommodated in the battery pack is less, thereby not performing effective cooling.

Therefore, there is a need for a battery pack with a new structure that can improve cooling efficiency while improving assembling because the structure is simple.

### DISCLOSURE

### Technical Problem

Therefore, the present disclosure was conceived to solve the above problems, and aims to provide a battery pack having a structure capable of effectively cooling a battery module accommodated therein.

Other objects and advantages of the present disclosure will be understood from the following description and will become apparent from the embodiments of the present disclosure. It will also be easily seen that the objects and advantages of the present disclosure may be realized by the means and combinations thereof disclosed in the claims of the patent.

### Technical Solution

According to the present disclosure, a battery pack for accommodating battery modules, including a pack case that includes a module area in which the battery modules are mounted, and the pack case including a base plate in the form of a hollow shape to support a lower part of a battery module and having a plurality of space parts formed therein for storing coolant; sidewalls coupled to a rim of the base plate; and a separation wall coupled to the base plate to separate the module area for mounting the battery modules; the separation wall comprising: a main separation wall extended and formed across the centered part of the pack case, wherein the base plate includes at both ends an inlet and an outlet through which coolant can flow in and out and communicated with the space part, respectively, wherein the base plate further includes a flow path part, and wherein the flow path part a plurality of cooling flow paths connecting the space parts to each other between a pair of adjacent space parts.

The coolant injected into the inlet may be discharged through the space part and the cooling flow path to the outlet.

The space parts may be formed separate at predetermined intervals along the length of the pack case.

The base plate may include an injection part including a space part formed at a front end of the base plate and directly communicated with the injection part, a discharge part including a space part formed at a rear end of the base plate and directly communicated with the outlet, and a temperature exchange part including a plurality of space parts formed at locations corresponding to each module area.

Each of the space parts included in the temperature exchange part may be formed corresponding to an area size of the module area.

Any one of the space parts included in the temperature exchange part may be communicated with respective cooling flow paths included in the flow path parts located at both ends of the space part, and the coolant flowing through the respective cooling flow paths of the flow path parts located at the front end of the space part may be joined in the space part, and the coolant joined in the space part may be dispersed and moved to the respective cooling flow paths of the flow path parts located at the rear end of the space part.

Coolant injected into the space part of the injection part through the inlet may be dispersed and moved to the respective cooling flows of the flow path parts adjacent to the space part of the injection part, and coolant moved through the respective cooling flows of the flow path parts adjacent to the space part of the discharge part may be joined in the space part of the discharge part and discharged through the outlet.

The space parts and flow path parts may be formed alternately along the length direction of the pack case.

The pack case may further include a sub-separation wall, which is coupled at both ends to the main separation wall and side wall and coupled to the base plate to separate between a pair of adjacent battery modules; and the flow path parts may be included at locations corresponding to the sub-separation wall.

The flow path parts may include a plurality of cooling flow paths, and the cooling flow paths included in the flow path parts may be arranged side by side along a width direction of the pack case.

The base plate may include a pair of inlets at a front end and a pair of outlets at a rear end connected to each of the inlets.

The inlet including a first inlet formed on one side of the main-separation wall wherein the first module area is located, and a second inlet formed on the other side of the main-separation wall wherein the second module area is located, and the outlet including a first outlet communicated with the first inlet on one side of the main-separation wall, and a second outlet communicated with the second inlet on the other side of the main-separation wall, wherein the first inlet may be positioned diagonally to the first outlet on one side of the main-separation wall, and the second inlet may be positioned diagonally to the second outlet on the other side of the main-separation wall.

The base plate may have an open from and rear side, and include a cooling cover coupled to the open front and rear sides.

The cooling cover may further include protrusions projecting forward, having a hollow shape, and the inlet and outlet may be installed in the protrusion parts of the cooling cover coupled to the front and rear sides of the pack case.

### Advantageous Effects

According to the present disclosure, a plurality of battery modules accommodated in a battery pack can be effectively cooled to prevent the battery pack from overheating and explosion.

### BRIEF DESCRIPTION OF THE DRAWINGS

FIG. 1 is a perspective view of a battery pack applied to an electric vehicle with a conventional water-cooled cooling system.

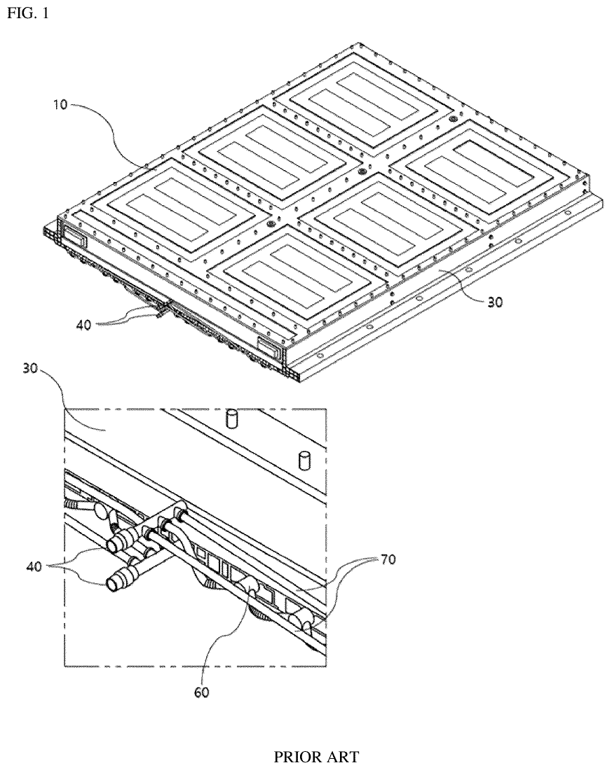

FIG. 2 is a front view of the battery pack of FIG. 1.

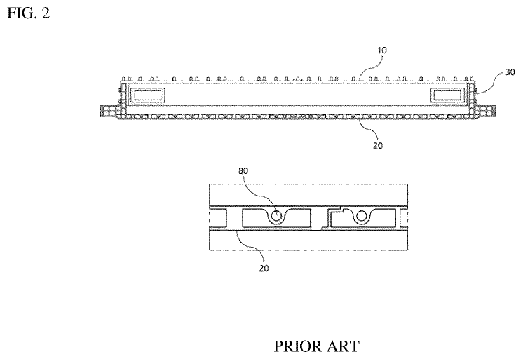

FIG. 3 is an illustration of a path for coolant to move through a flow path in the battery pack of FIG. 1.

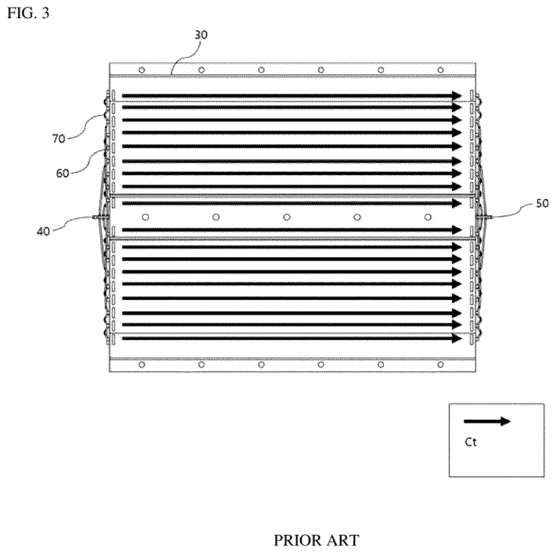

FIG. 4 is a perspective view of a battery pack according to a first embodiment of the present disclosure.

FIG. 5 is a modified embodiment of the battery pack shown in FIG. 4.

FIG. 6 is a front view of the battery pack of FIG. 4.

FIG. 7 is a top view of a pack case of the present disclosure.

FIG. 8 is an illustration of cooling flow paths and space parts inside the base plate corresponding to the first module area and the second module area in the pack case of FIG. 7.

FIG. 9 is a partial cross-sectional view of the pack case of FIG. 7.

FIG. 10 illustrates a movement path of the coolant through the cooling flow path and space parts of FIG. 8.

FIG. 11 is a perspective view of a battery pack according to a second embodiment of the present disclosure.

FIG. 12 is a partial view of a cooling cover with the protrusion part.

### DETAILED DESCRIPTION OF THE PREFERRED EMBODIMENTS

Hereinafter, the present disclosure will be described in detail with reference to the drawings. Prior to this, terms and words used in the present specification and claims should not be construed as limited to general or dictionary terms and should be interpreted with the meaning and concept in accordance with the technical idea of the present disclosure based on the principle that the inventors have appropriately defined the concepts of terms in order to explain the disclosure in the best way.

Accordingly, it is to be understood that the embodiments described herein and the configurations illustrated in the drawings are only the most preferred embodiments of the disclosure and do not represent all of the technical ideas of the disclosure, and that there may be various equivalents and modifications that may be substituted for them at the time of filing.

In addition, in describing the present disclosure, specific descriptions of related prior art configurations or features are omitted where it is deemed that such descriptions would obscure the essence of the disclosure.

Since the embodiments of the present disclosure are provided to illustrate the disclosure more fully to those of ordinary skill in the art, the shapes and sizes of the components in the drawings may be exaggerated, omitted, or shown schematically for clarity. Accordingly, the dimensions or proportions of each component are not necessarily indicative of actual dimensions or proportions.

The present disclosure relates to a battery pack 1000 accommodating a battery module B. More specifically, the battery pack 1000 of the present disclosure is characterized in that it includes a pack case 200 capable of effectively cooling the accommodated battery module B.

The pack case 200 is provided in the present disclosure.

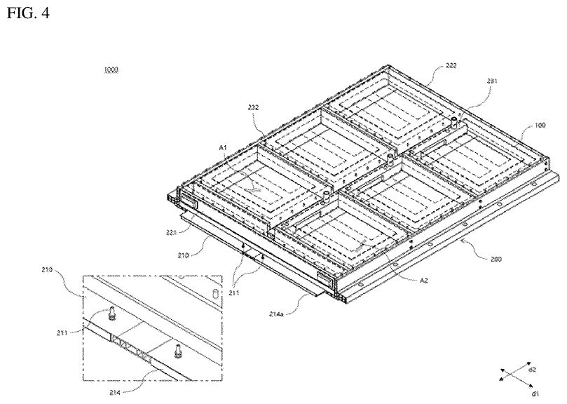

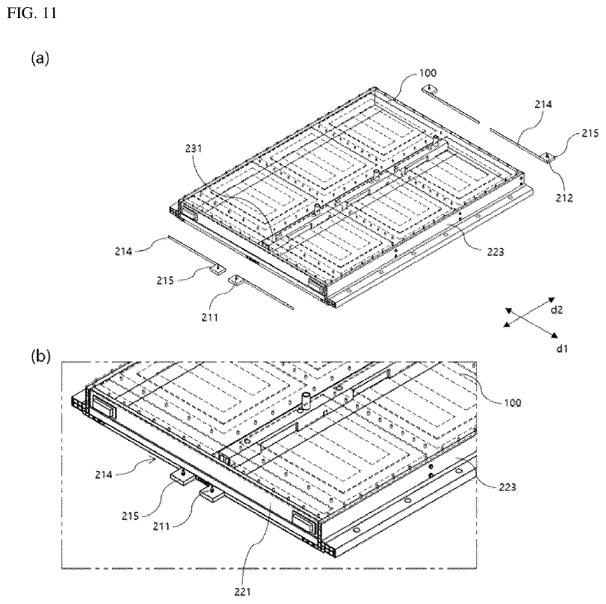

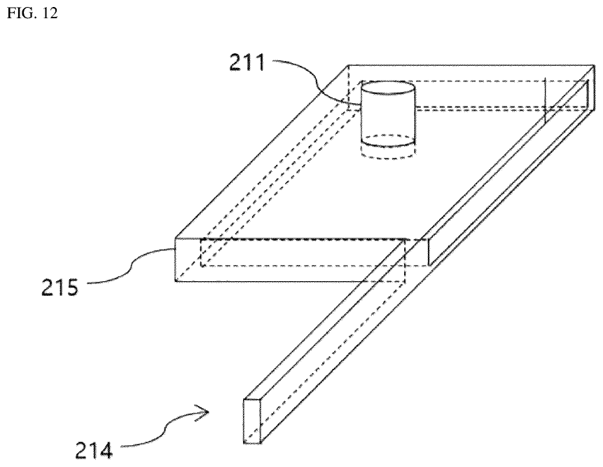

FIGS. 4 to 10 relate to a battery pack 1000 according to a first embodiment of the present disclosure, and FIGS. 11 and 12 relate to a battery pack 1000 according to a second embodiment of the present disclosure.

Hereinafter, the battery pack 1000 of the present disclosure will be described with reference to the above drawings.

### First Embodiment

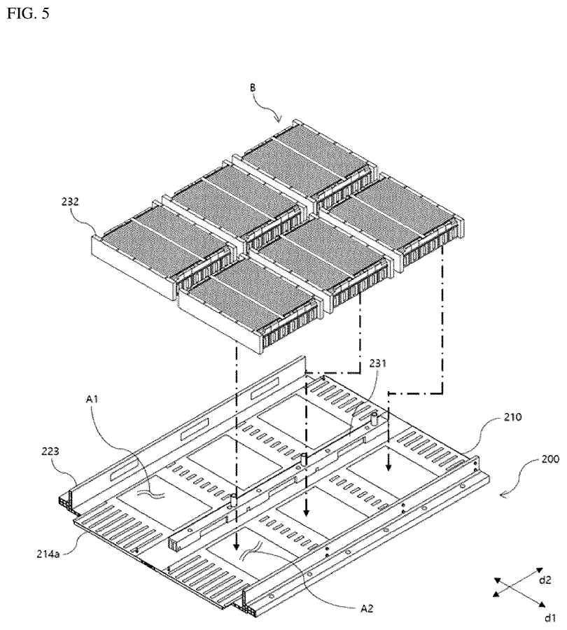

FIG. 4 is a perspective view of a battery pack according to a first embodiment of the present disclosure. FIG. 5 is a modified embodiment of the battery pack shown in FIG. 4.

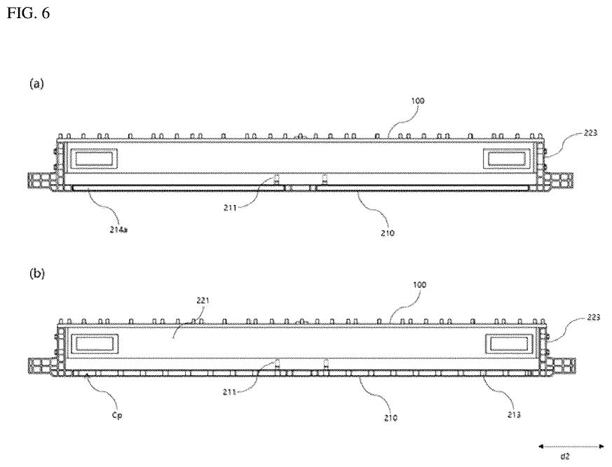

FIG. 6 is a front view of the battery pack of FIG. 4.

The battery pack 1000 of the present disclosure, as shown in FIG. 4 includes a pack case 200 and a top cover 100.

The top cover 100 is coupled with the pack case 200 to cover the top of each battery module B accommodated in the pack case 200.

Since the top cover 100 corresponds to the known art, a detailed description thereof will be omitted herein.

The pack case 200 includes a base plate 210, sidewall and separation wall, and provides a module area A in which a battery module B is mounted.

The sidewalls are coupled along a rim of the base plate 210.

More specifically, the sidewalls include a front frame 221 coupled to the base plate 210 to cover the front of the base plate 210, a rear frame 222 coupled to the base plate 210 to cover the rear of the base plate 210, and side frames 223 coupled on both sides of the base plate 210 to cover the sides of the base plate 210.

The battery pack 1000 according to a first embodiment of the present disclosure has a front end of the base plate 210 projecting toward the front of the front frame 221 and a rear end of the base plate 210 projecting toward the rear of the rear frame 222.

More specifically, the front frame 221 is coupled to the base plate 210 at a position predetermined spaced apart from the front end of the base plate 210 such that the front end of the base plate 210 can project forwardly of the front end of the front frame 221.

Further, the rear frame 222 is coupled with the base plate 210 at a predetermined spaced position from the rear end of the base plate 210 such that the rear end of the base plate 210 can project toward the front of the rear frame 222.

The separation wall is coupled to the base plate 210 to separate a module area A in which each battery module B is mounted.

More specifically, the separation walls includes a main-separation wall 231 formed to extend across the center part of the pack case 200.

The pack case 200 may be largely separated into two spaces by each of the main-separation wall 231, and a plurality of battery modules B may be mounted on the base plate 210 side by side along the main-separation wall 231 on both sides of the main-separation wall 231. At this time, the battery modules B accommodated on one side of the main-separation wall 231 may be further separated by the sub-separation wall 232.

In other words, the pack case 200, as shown in FIG. 4 may further include a sub-separation wall 232 that separates the space formed by the main-separation wall 231 in the length direction d1 of the pack case 200 to form a module area A in which the battery module B is mounted.

The sub-separation wall 232 may be installed in the pack case 200 separately from the battery module B, but may be provided attached to the battery module B in another embodiment.

FIG. 5 is a perspective view of the pack case 200 accommodating battery modules B with sub-separation wall 232 attached on both sides, wherein each battery module B is separated and supported by a sub-separation wall 232 attached to a side of the battery module B as the battery module B is mounted in each module area A.

The base plate 210 is characterized in that it has a hollow shape, supports the lower part of the battery module B, and includes inside a plurality of space parts Cv in which the coolant is stored.

The base plate 210 is open at the front and rear sides, and includes a cooling cover 214 coupled to the front and rear sides to cover the open front and rear sides.

FIG. 6(a) is a battery pack 1000 with the cooling cover 214 coupled, and FIG. 6(b) is a battery pack 1000 with the cooling cover 214 detached.

The cooling cover 214 may be divided into a first cooling cover 214a coupled to the front side of the base plate 210 and a second cooling cover coupled to the rear side of the base plate 210.

The inside of the base plate 210 is hollow, as shown in FIG. 6, and a plurality of separation walls 213 are formed inside the hollow, which are built up in the direction of the thickness of the base plate 210. The cooling cover 214 is coupled with the base plate 210 so as to cover the open front and rear sides of the base plate 210. In this case, the cooling cover 214 may be separately detachable from the base plate 210 as shown or may be integrally manufactured with the base plate 210.

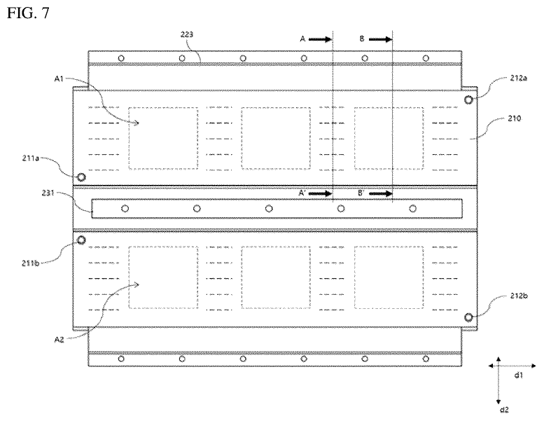

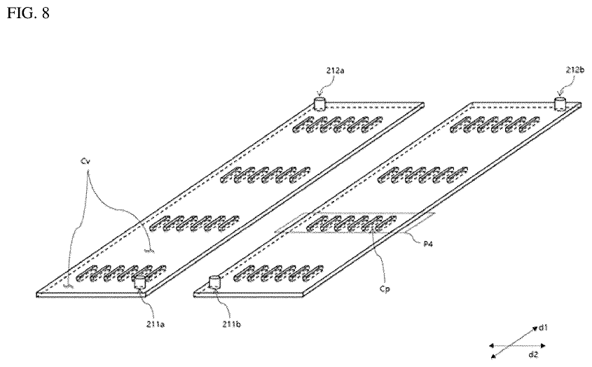

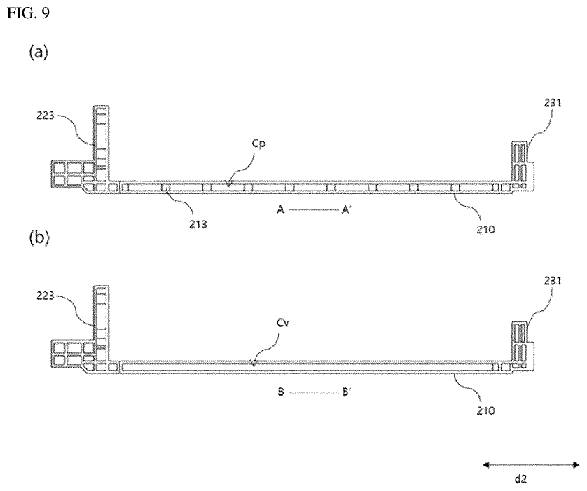

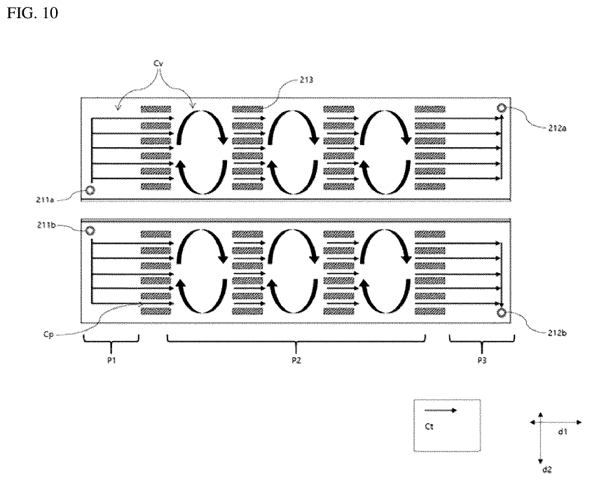

FIG. 7 is a top view of a pack case of the present disclosure. FIG. 8 is an illustration of cooling flow paths and space parts inside the base plate corresponding to the first module area and the second module area in the pack case of FIG. 7. FIG. 9 is a partial cross-sectional view of the pack case of FIG. 7. FIG. 10 illustrates a movement path of the coolant through the cooling flow path and space parts of FIG. 8.

The first module area A1 and the second module area A2 are formed at predetermined intervals spaced apart along the length direction d1 of the pack case 200 on both sides of the main-separation wall 231, and each battery module B is mounted in the respective module area A.

The battery pack 1000 of the present disclosure is characterized in that it effectively cools the battery modules B accommodated therein, the cooling being accomplished by allowing coolant to flow inside a base plate 210 included in the pack case 200.

In particular, the present disclosure forms a plurality of space parts Cv inside the base plate 210 to maximize the cooling effect, and enables the coolant to exchange temperature with the battery module B through a large area of the space part Cv.

The space part Cv is formed at predetermined intervals spaced apart along the length direction d1 of the pack case 200, same as the module area A.

The base plate 210 of the present disclosure further includes an inlet 211, an outlet 212, and a flow path part P4 in addition to the space part Cv.

Referring to FIGS. 4 to 7, wherein the inlet 211 and outlet 212 are portions at which coolant flows in and out, the base plate 210 includes an inlet 211 and an outlet 212, respectively, at both ends. More specifically, the inlet 211 is installed at the front end of the base plate 210 protruding a predetermined length from the front frame 221, and the outlet 212 is installed at the rear end of the base plate 210 protruding a predetermined length from the rear frame 222.

Coolant injected into the base plate 210 to cool the battery module B enters the inside of the base plate 210 through the inlets 211 and discharges to the outside through the outlet 212 connected to the inlet 211.

The base plate 210 includes a pair of inlets 211 at a front end and a pair of outlets 212 at a rear end connected to each of the inlet 211.

Referring to FIG. 7, a pair of inlets 211 are separately located at the front end of the base plate 210 across the main-separation wall 231, and a pair of outlets 212 are separately located at the rear end of the base plate 210.

More specifically, the inlets 211 include a first inlet 211a formed on one side of the main-separation wall 231 where the first module area A1 is located and a second inlet 211b formed on the other side of the main-separation wall 231 where the second module area A2 is located.

Further, the outlet 212 includes a first outlet 212a formed on one side of the main-separation wall 231 where the first module area A1 is located and a second outlet 212b formed on the other side of the main-separation wall 231 where the second module area A2 is located.

Each of the connected inlets 211 and outlets 212 is preferably positioned diagonally to each other on the base plate 210.

More specifically, the first inlet 211a is installed in a diagonal direction with respect to the first outlet 212a on one side of the main-separation wall 231, and the second inlet 211b is installed in a diagonal direction with respect to the second outlet 212b on the other side of the main-separation wall 231.

The first inlet 211a and second inlet 211b are installed at a position adjacent to the main-separation wall 231 at the front end of the base plate 210, respectively and the first outlet 212a and second outlet 212b are installed at a position adjacent to the side frames 223 located on both sides of the base plate 210 at the rear end of the base plate 210, respectively.

The flow path part P4 includes a plurality of cooling flow paths connecting the space parts Cv to be connected to each other between a pair of adjacent space parts Cv.

Referring to FIG. 8, the cooling flow paths are formed to extend along the length direction d1 of the pack case 200, and the plurality of cooling flow paths included in the flow path part P4 are arranged side by side along the width direction d2 of the pack case 200.

The flow path part P4 is located between the space parts Cv separated at predetermined intervals along the length direction d1 of the pack case 200. Therefore, coolant can move from one of the space parts Cv to the other space part Cv through the cooling flow paths included in the flow path part P4.

The coolant injected into the inlet 211 is discharged to the outlet 212 through the space part Cv and the cooling flow path.

The flow path part P4 is formed corresponding to a location of a boundary point position between a pair of adjacent module areas A. More specifically, the flow path parts P4 are formed in a position corresponding to the sub-separation wall 232 installed at the boundary points of the module areas A.

In FIG. 9, a cross-sectional view cutting a position between a pair of module areas A in the pack case 200 of FIG. 7 and a cross-sectional view cutting the module areas A are shown, respectively.

Referring to FIG. 9(a), in the cross-section of the pack case 200 with the position between the pair of module areas A being cut, a plurality of separation walls 213 formed at predetermined intervals along the width direction d2 of the pack case 200 and a plurality of cooling flow paths formed between the separation walls 213 are formed.

In other words, each cooling flow path included in the above one flow path part P4 is formed by a separation wall 213 formed to be spaced apart by a predetermined interval in the inner hollow of the base plate 210, that is, one cooling flow path is formed by an adjacent pair of separation walls 213.

Also, referring to the FIG. 9(b), in the cross-section of the pack case 200 with the module area A location to be cut, one space part Cv is formed between the side frame 223 and the main-separation wall 231.

The coolant flowing through each of the cooling flow paths in FIG. 9(a) is joined in the space part Cv in FIG. 9(b) connected to the cooling flow paths, and the large area of the space part Cv cools the battery module B mounted in the module area A corresponding to the space part Cv.

The space parts Cv are formed on each side of the base plate 210 based on the main-separation wall 231, and are formed corresponding to the positions of the module areas A along the length direction d1 of the pack case 200.

Therefore, the space part Cv and the flow path part P4 formed on one side of the main-separation wall 231 are formed alternately with each other along the length direction d1 of the pack case 200.

According to FIG. 10, the inside of the base plate 210 is divided into three main sections, that is, the base plate 210 includes an injection part P1, a discharge part P3, and a temperature exchange part P2.

The injection part P1 includes a space part Cv formed at the front end of the base plate 210 and directly communicated with the inlet 211.

The coolant flowed into the space part Cv of the injection part P1 through the inlet 211 is dispersed and moved to each cooling oil in the flow path part P4 adjacent to the space part Cv of the injection part P1, as shown in FIG. 10.

The discharge part P3 includes a space part Cv formed at the rear end of the base plate 210 and directly communicated with the outlet 212.

The coolant that has moved through each coolant flow path of the flow path part P4 adjacent to the space part Cv of the discharge part P3 is joined at the space part Cv of the discharge part P3 and discharged through the outlet 212.

The temperature exchange part P2 is located between the injection part P1 and the discharge part P3, and includes a plurality of space parts Cv formed at positions corresponding to the respective module areas A.

Since each space part Cv included in the temperature exchange part P2 is formed for the purpose of cooling each battery module B installed in the corresponding module area A through the largest possible surface area, so it is preferably formed corresponding to the area size of the module area A or the size of the battery module B installed in the module area A.

At least one space part Cv included in the temperature exchange part P2 is communicated with each coolant flow path of the flow path part P4 located at the front and rear sides, respectively.

Referring to FIG. 10, the coolant flowing through each coolant flow path of the flow path part P4 located in front of the space part Cv is joined in the space part Cv. The joined coolant is dispersed to each coolant flow path of the flow path part P4 located at the rear of the space part Cv and moves to the next space part Cv.

### Second Embodiment

The battery pack 1000 according to the second embodiment of the present disclosure differs from the battery pack 1000 according to the first embodiment in the location where the inlet 211 and outlet 212 through which coolant flows in and out are installed.

The battery pack 1000 according to the second embodiment has a front frame 221 and a rear frame 222 coupled to the base plate 210 and coupled to a front end and a rear end of the base plate 210, respectively.

FIG. 11 is a perspective view of a battery pack 1000 according to a second embodiment of the present disclosure. Specifically, FIG. 11(a) shows a cooling cover 214 detached from a base plate 210, and FIG. 11(b) shows the cooling cover 214 coupled to the base plate 210.

The base plate 210 included in the battery pack 1000 includes a cooling cover 214 that is open at the front and back and is coupled to cover the openings with the open front and back sides.

The cooling cover 214 further includes a forwardly projecting protrusion part 215.

The protrusion part 215 is molded with an inlet 211 or outlet 212 through which coolant flows in and out.

The inlet 211 and the outlet 212 is connected to the inlet 211 are preferably located diagonally to each other on the base plate 210. Therefore, the protrusion part 215 disposed in the cooling cover 214, which includes the inlet 211 and is located at the front end of the base plate 210 and the protrusion parts 215 disposed in the cooling cover 214, which includes the outlet 212 connected to the inlet 211, and is located at the rear end of the base plate 210, are positioned diagonally each other.

Referring to FIG. 11, a protrusion part 215 of the cooling cover 214 located at the front end of the base plate 210 is formed at one end of the two ends of the cooling cover 214 adjacent to the main-separation wall 231, and a protrusion part 215 of the cooling cover 214 opposite the cooling cover 214 and located at the rear end of the base plate 210 is formed at one end of the two ends of the cooling cover 214 adjacent to the side frame 223.

FIG. 12 illustrates a portion of the cooling cover 214 including the protrusion part 215. The protrusion part 215 projecting from the cooling cover 214 is in the form of an inlet 211 formed at the top and a hollow interior. Further, the interior hollow is open to one side and the coolant introduced through the inlet 211 flows through one side of the open protrusion part 215 to the inside of the base plate 210 coupled to the cooling cover 214.

The present disclosure has been described in detail. However, this does not limit the present disclosure to the specific embodiments, and all modifications, equivalents, or substitutes included in the spirit and technical scope of the present disclosure should be understood as belonging to the present disclosure. It should be understood that the detailed description and specific examples, while indicating preferred embodiments of the disclosure, are given by way of illustration only, since various changes and modifications within the scope of the disclosure will become apparent to those skilled in the art from this detailed description.

### DESCRIPTION OF REFERENCE NUMERALS

10: (related art) top cover
20: (related art) base plate
30: (related art) side wall
40: (related art) inlet
50: (related art) outlet
60: (related art) auxiliary inlet
70: (related art) hose
80: (related art) flow path
1000: battery pack
100: top cover
200: pack case
210: base plate
211: inlet
211a: first inlet
211b: second inlet
212: outlet
212a: first outlet
212b: second outlet
213: separation wall
214: cooling cover
214a: first cooling cover
215: protrusion part
221: front frame
222: rear frame
223: side frame
231: main-separation wall
232: sub-separation wall
A: module area
A1: first module area
A2: second module area
B: battery module
Ct: coolant movement path
Cv: space part
d1: length direction of pack case
d2: width direction of pack case
P1: injection part
P2: temperature exchange part
P3: discharge part
P4: flow path part

1. A battery pack for accommodating battery modules, comprising: a pack case that comprises a module area in which the battery modules are mounted, and wherein the pack case includes a base plate defining a hollow shape to support a lower part of a battery module and having a plurality of space parts formed therein one of the for storing coolant; sidewalls coupled to a rim of the base plate; and a separation wall coupled to the base plate to separate the module area for mounting the battery modules;
wherein the separation walls comprise a main-separation wall extended and formed across a central part of the pack case,
wherein the base plate includes an inlet and an outlet at both ends through which coolant can flow in and out, the inlet and the outlet being communicated with the space parts,
wherein the base plate further includes a flow path part, and
wherein the flow path part includes a plurality of cooling flow paths connecting the space parts to each other between a pair of adjacent space parts.

2. The battery pack of claim 1, wherein the coolant injected into the inlet is discharged through the space parts and the cooling flow path to the outlet.

3. The battery pack of claim 1, wherein the space parts are separated from one another at predetermined intervals along a length direction of the pack case.

4. The battery pack of claim 1, wherein the base plate comprises an injection part comprising a space part formed at a front end of the base plate and directly communicated with the injection part,
a discharge part comprising a space part formed at a rear end of the base plate and directly communicated with the outlet, and
a temperature exchange part comprising a plurality of space parts formed at locations corresponding to each module area.

5. The battery pack of claim 4, wherein each of the space parts included in the temperature exchange part is sized to corresponding to an area of the module area.

6. The battery pack of claim 4, wherein any one of the space parts included in the temperature exchange part is communicated with respective cooling flow paths included in the flow path parts located at both ends of the space part such that
the coolant flowing through the respective cooling flow paths of the flow path parts located at the front end of the space part is joined in the space part, and
the coolant joined in the space part is dispersed and moved to the respective cooling flow paths of the flow path parts located at the rear end of the space part.

7. The battery pack of claim 4, wherein coolant injected into the space part of the injection part through the inlet is configured to be dispersed and moved to the respective cooling flows of the flow path parts adjacent to the space part of the injection part, and
coolant moved through the respective cooling flow paths adjacent to the space part of the discharge part is joined in the space part of the discharge part and discharged through the outlet.

8. The battery pack of claim 1, wherein the space parts and the flow path parts are formed alternately along a length direction of the pack case.

9. The battery pack of claim 1, wherein the pack case further comprises a sub-separation wall, which is coupled at both ends to the main-separation wall and side wall and coupled to the base plate to separate between a pair of adjacent battery modules, and the flow path part is disposed at locations corresponding to the sub-separation wall.

10. The battery pack of claim 1, wherein the flow path parts comprise a plurality of cooling flow paths, and the cooling flow paths included in the flow path parts are arranged side by side along a width direction of the pack case.

11. The battery pack of claim 1, wherein the base plate comprises a pair of inlets at a front end and a pair of outlets at a rear end connected to each of the inlets.

12. The battery pack of claim 11,
wherein the pair of inlets comprises a first inlet formed on one side of the main-separation wall wherein a first module area is located, and a second inlet formed on the other side of the main-separation wall wherein a second module area is located, and
the pair of outlets comprises a first outlet communicated with the first inlet on one side of the main-separation wall, and a second outlet communicated with the second inlet on the other side of the main-separation wall,
wherein the first inlet is positioned diagonally to the first outlet on one side of the main-separation wall, and the second inlet is positioned diagonally to the second outlet on the other side of the main-separation wall.

13. The battery pack of claim 1, wherein the base plate has an open front and rear side, and comprises a cooling cover coupled to the open front and rear sides of the pack case.

14. The battery pack of claim 13, wherein the cooling cover comprises protrusions projecting forward, having a hollow shape, and the inlet and the outlet are installed in the protrusion of the cooling cover coupled to the front and rear sides of the pack case.
